(19) United States
(12) Patent Application Publication
(10) Pub. No.: US 2012/0311113 A1
(43) Pub. Date: Dec. 6, 2012

(54) STORAGE DEVICE

(75) Inventor: Yu Nagata, Tokyo (JP)

(73) Assignee: NEC CORPORATION, Tokyo (JP)

(21) Appl. No.: 13/577,093

(22) PCT Filed: Oct. 19, 2010
(86) PCT No.: PCT/JP2010/006170

§ 371 Date: Aug. 3, 2012

(30) Foreign Application Priority Data
Feb. 10, 2010 (JP) 2010-027123

(51) Int. Cl. G06F 15/173

(52) U.S. Cl. 709/221

(57) ABSTRACT

A storage device 101 includes: a connection managing means 102 for managing a status of a connection between network ports 111 to 114 and client devices 121 to 124 connected via the network ports; a storage processing means 103 for receiving write target data transmitted from the client devices and storing the data into a predetermined storage device 105; and a data characteristics measuring means 104 for executing measurement of a predetermined characteristic of predetermined data received when a write request is made by the client devices. The connection managing means 102 changes the network port connected with the client devices in accordance with a result of the measurement by the data characteristics measuring means.

### TECHNICAL FIELD

The present invention relates to a storage device, more specifically, a storage device connected to a network.

### BACKGROUND ART

In recent years, various kinds of information are digitalized with development and spread of computers. As a device for storing such digital data, there is a storage device such as a magnetic tape and a magnetic disk. Because the amount of data that should be stored increases day by day and reaches a huge amount, a mass storage system is required. Moreover, as well as reduction of the cost spent for a storage device, reliability is also required. In addition, it is also required that data can be easily retrieved later. As a result, a storage system that can automatically realize increase of storage capacity and performance, eliminates duplicated storage to reduce a storage cost and has high redundancy is desired.

Under such a circumstance, in recent years, as shown in Patent Document 1, a content-addressable storage (CAS) system has been developed. This content-addressable storage system distributes and stores data into a plurality of storage devices and, by a unique content address specified depending on the content of the data, specifies a storage position where the data is stored. To be specific, a content-addressable storage system divides predetermined data into a plurality of fragments and adds a fragment as redundant data, and then stores these fragments into a plurality of storage devices, respectively.

Later, it is possible to designate a content address to retrieve data, namely, fragments stored in a storage position specified by the content address and restore the predetermined data before being divided from the fragments.

Further, the content address uses a value generated so as to be unique depending on the content of data, for example, a hash value of data. Therefore, in the case of duplicated data, it is possible to refer to data in the same storage position and acquire data having the same content. Consequently, it is unnecessary to store the duplicated data separately, and it is possible to eliminate duplicated recording and reduce the data capacity.

[Patent Document 1] Japanese Unexamined Patent Application Publication No. 2005-235171

To the abovementioned content-addressable storage system, data to be backed up and so on are transmitted from a predetermined computer via a network. However, because the system uses a virtualized storage, there is a problem that a client side cannot judge the performance and characteristics of the storage side, and consequently, a load balance is lost. That is to say, there is a problem of load on a network port of the storage side connected with the client, and it is difficult to allocate a network port with efficiency.

For example, a plurality of network ports can be presented as one network port to the client (i.e., aggregation). One method for network port aggregation is to determine a network port of a destination at the time of ARP (Address Resolution Protocol) solution by a round robin method and keep using the network port.

However, by the abovementioned network port allocation method, it is impossible to distribute load of a plurality of connections whose network load balances are different by using all of the network ports. Therefore, there is a problem that efficiency in use of a network port decreases. Then, such a problem may occur not only in a content-addressable storage system but also in all storage devices.

### SUMMARY

Accordingly, an object of the present invention is to solve the abovementioned problem, “decrease of efficiency in use of a network port connected with a storage device.”

In order to achieve the object, a storage device of an exemplary embodiment of the present invention includes:

a connection managing means for managing a status of a connection between network ports and client devices connected via the network ports;

a storage processing means for receiving write target data transmitted from the client devices and storing the data into a predetermined storage device;

and a data characteristics measuring means for executing measurement of a predetermined characteristic of predetermined data received when a write request is made by the client devices.

The connection managing means is configured to change the network ports connected with the client devices in accordance with a result of the measurement by the data characteristics measuring means.

Further, a storage system of another exemplary embodiment of the present invention includes a storage device and a switch device having a plurality of network ports relaying a connection between the storage device and client devices via a network.

The storage device includes:

a connection managing means for controlling an operation of the switch device and managing a status of a connection between the client devices and the connected network ports;

a storage processing means for receiving write target data transmitted from the client devices and storing the data into a predetermined storage device;

and a data characteristics measuring means for executing measurement of a predetermined characteristic of predetermined data received when a write request is made by the client devices.

Furthermore, the connection managing means of the storage device is configured to change the network ports connected with the client devices in accordance with a result of the measurement by the data characteristics measuring means.

Further, a program of another exemplary embodiment of the present invention is a computer program including instructions for causing an information processing device to realize:

a connection managing means for managing a status of a connection between network ports and client devices connected via the network ports;

a storage processing means for receiving write target data transmitted from the client devices and storing the data into a predetermined storage device; and

a data characteristics measuring means for executing measurement of a predetermined characteristic of predetermined data received when a write request is made by the client devices.

The connection managing means is configured to change the network ports connected with the client devices in accordance with a result of the measurement by the data characteristics measuring means.

Further, a data processing method of another exemplary embodiment of the present invention is a data processing method including:

managing a status of a connection between network ports and client devices connected via the network ports; and

receiving write target data transmitted from the client devices and storing the data into a predetermined storage device.

The data processing method includes executing measurement of a predetermined characteristic of predetermined data received when a write request is made by the client devices and, in accordance with a result of the measurement, changing the network ports connected with the client devices.

With the configurations described above, the present invention can realize proper allocation of a network port in response to a write request from a client device.

### BRIEF DESCRIPTION OF DRAWINGS

FIG. 1 is a block diagram showing a configuration of a storage system in a first exemplary embodiment of the present invention;

FIG. 2 is an explanation view showing an aspect of a data write process in the storage system disclosed in FIG. 1;

FIG. 3 is an explanation view showing an aspect of a data write process in the storage system disclosed in FIG. 1;

FIG. 4 is a view showing an example of a client device table disclosed in FIG. 1;

FIG. 5 is a flowchart showing an operation of the storage system disclosed in FIG. 1;

FIG. 6 is a flowchart showing an operation of the storage system disclosed in FIG. 1;

FIG. 7 is a flowchart showing an operation of the storage system disclosed in FIG. 1;

FIG. 8 is a block diagram showing a configuration of a storage system according to a second exemplary embodiment of the present invention;

FIG. 9 is a flowchart showing an operation of the storage system disclosed in FIG. 8;

FIG. 10 is a flowchart showing an operation of the storage system disclosed in FIG. 8; and

FIG. 11 is a block diagram showing a configuration of a storage system according to supplementary note 1 of the present invention.

### EXEMPLARY EMBODIMENTS

### First Exemplary Embodiment

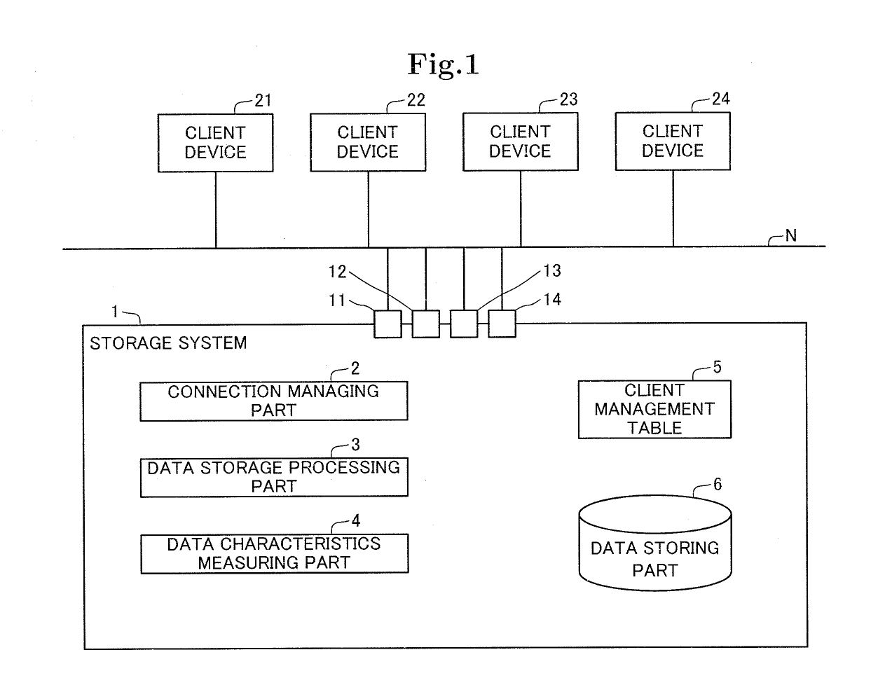

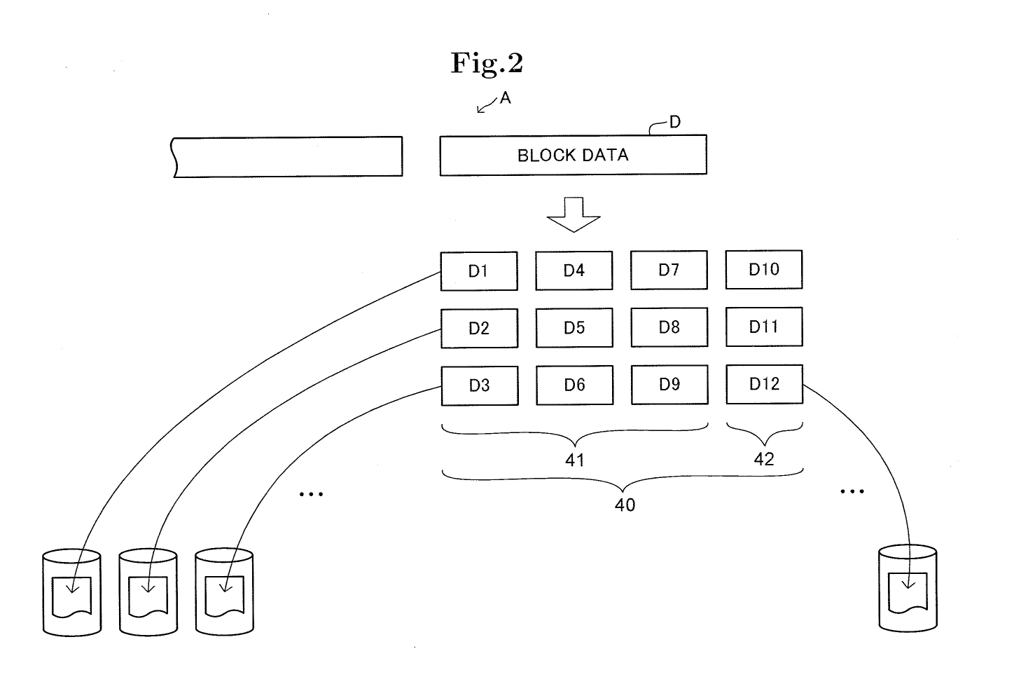

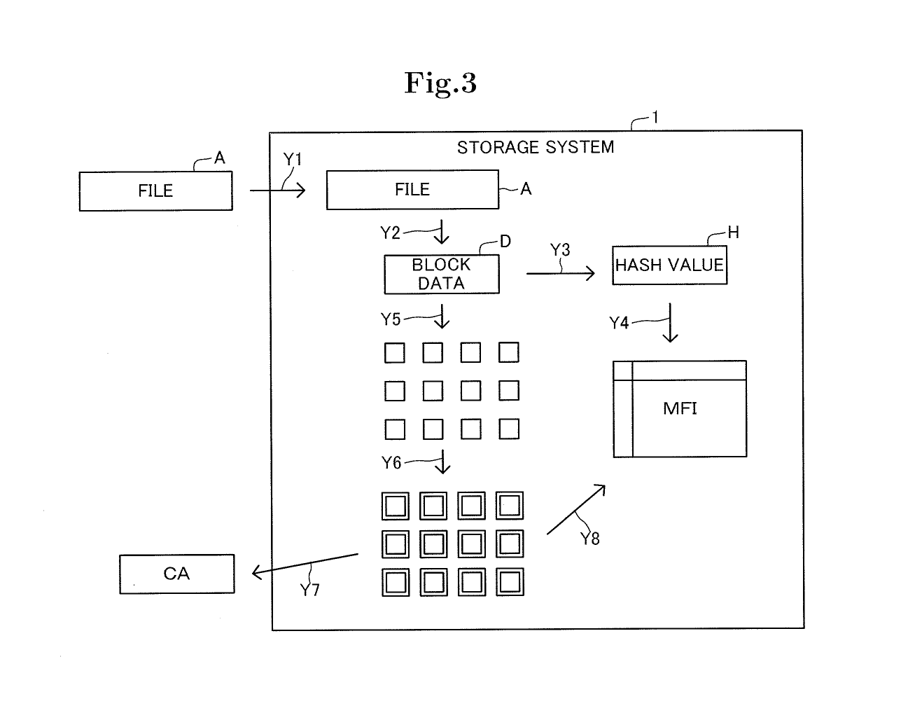

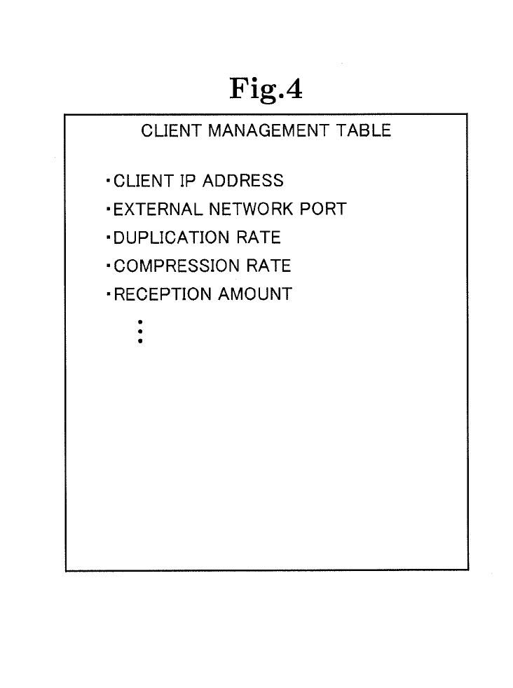

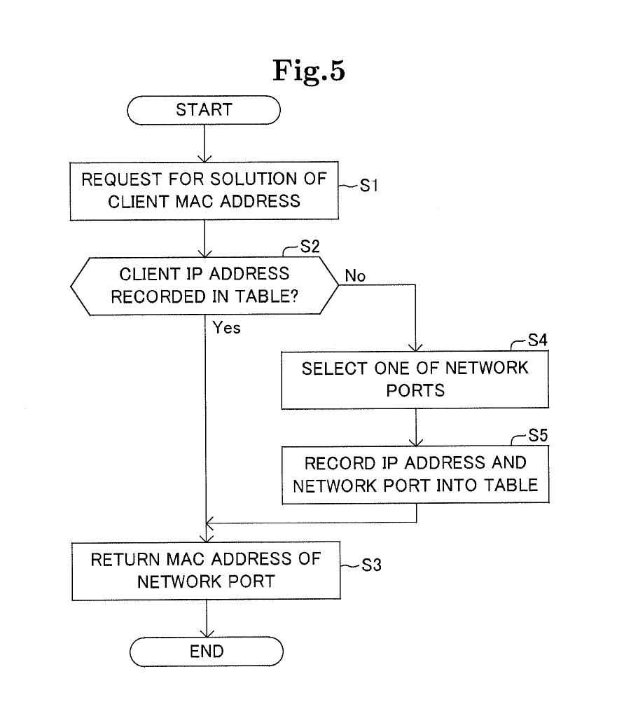

A first exemplary embodiment of the present invention will be described with reference to FIGS. 1 to 7. FIG. 1 is a block diagram showing a configuration of a storage system in this exemplary embodiment. FIGS. 2 and 3 are explanation views showing an aspect of a data write process. FIG. 4 is a view showing an example of a client management table. FIGS. 5 to 7 are flowcharts showing an operation of the storage system.

[Configuration]

A storage system 1 in this exemplary embodiment is connected with a plurality of client devices 21 to 24 each making a request for writing predetermined data such as data that needs to be backed up, via a network N as shown in FIG. 1. The storage system 1, which is equipped with a plurality of external network ports 11 to 14, is connected with the client device 21, 22, 23 or 24 having made a write request via any of the external network ports 11 to 14.

Although the storage system 1 is equipped with the four external network ports 11 to 14, the number of which is not limited to four, the storage system may be equipped with any number of external network ports. Moreover, the external network ports 11 to 14 do not need to be integrally disposed to the storage system 1, and may be configured by physically separated switch devices. Furthermore, the number of the client devices 21 to 24 making data write requests to the storage system 1 is not limited to the number shown in FIG. 1.

The storage system 1 in this exemplary embodiment is a content-addressable storage system that distributes and stores data into a plurality of storage devices and that specifies a storage position where the data is stored by a unique content address specified in accordance with the content of the data. The storage system 1 is configured by connecting a plurality of server computers. However, the storage system of the present invention is not limited to being configured by a plurality of computers, and may be configured by one computer.

Below, on the assumption that the storage system 1 is one system as shown in FIG. 1, a configuration and function of the storage system 1 will be described. That is to say, a configuration and function of the storage system 1 described below may be disposed to any of the server computers configuring the storage system 1.

As shown in FIG. 1, the storage system 1 in this exemplary embodiment includes a connection managing part 2, a data storage processing part 3 and a data characteristics measuring part 4, which are constructed by installation of a program in an arithmetic device such as a CPU (Central Processing Unit) incorporated therein. Moreover, in a storage device such as a hard disk incorporated therein, a data storing part 6 storing data requested to be written by any of the client devices 21 to 24 and a client management table 5 are formed.

Here, a specific data write process by the data storage processing part 3 (a storage processing means) will be described with reference to FIGS. 2 and 3. When an input of a file A that is data to be written from the client device is accepted as shown by an arrow Y1 in FIG. 3, the data storage processing part 3 divides the file A into block data D of a predetermined capacity (e.g., 64 KB) as shown by an arrow Y2 in FIGS. 2 and 3. Then, based on a data content of this block data D, a unique hash value H (content identification information) representing the data content is calculated (an arrow Y3). For example, a hash value H is calculated based on the data content of block data D by using a preset hash function.

The data storage processing part 3 has a duplication determination function to check by using a hash value H of block data D of a file A whether the block data D has already been stored in the storage device. To be specific, firstly, in a case that the block data D has already been stored, a hash value H thereof and a content address CA representing a storage position thereof have been associated and registered in an MFI (Main Fragment Index) file. Therefore, in the duplication determination function, in a case that a hash value H of block data D calculated before being stored exists in the MFI file, it is possible to judge that block data D having the same content has already been stored (an arrow Y4 of FIG. 3). In this case, a content address CA associated with the hash value H in the MFI, which coincides with the hash value H of the block data D before being stored, is acquired from the MFI file. Then, this content address CA is returned as the content address CA that is the storage position of the data having the same content as the block data D requested to be stored. Consequently, the already stored data referred to with this content address CA is used as the block data D requested to be stored, and it is no more necessary to store the block data D requested to be stored.

Further, the data storage processing part 3 has a block compression function to compress block data D judged not to be stored yet in the duplication determination function as described above. As shown by an arrow Y5 in FIG. 3, the data storage processing part 3 divides the block data D into a plurality of fragment data of a predetermined capacity. For example, the data storage processing part 3 divides the block data D into nine pieces of fragment data (division data 41) as shown by reference numerals D1 to D9 in FIG. 2. Moreover, the data storage processing part 3 generates redundant data so as to be capable of restoring the original block data even when some of the division fragment data are lost, and adds the redundant data to the division fragment data 41. For example, the data storage processing part 3 adds three pieces of fragment data (redundant data 42) as shown by reference numerals D10 to D12 in FIG. 2. Consequently, a data set 40 that includes twelve pieces of fragment data configured by the nine pieces of division data 41 and the three pieces of redundant data is generated.

The data storage processing part 3 then distributes and stores the fragment data configuring the data set generated as described above into the data storing part 6 configured by a plurality of storage devices, respectively. For example, in the case of generating the twelve pieces of fragment data D1 to D12 as shown in FIG. 2, the data storage processing part 3 stores the fragment data D1 to D12 one by one into the data storage files formed in the twelve storage devices, respectively (refer to an arrow Y6 in FIG. 3).

Further, the data storage processing part 3 generates and manages a content address CA representing a storage position of the fragment data D1 to D12, that is, a storage position of the block data D to be restored based on the fragment data D1 to D12 stored in the storage devices as described above. To be specific, the data storage processing part 3 generates the content address CA by combining part (a short hash: e.g., initial 8 B (bytes) of the hash value H) of the hash value H calculated based on the content of the stored block data D with information representing a logical storage position. The data storage processing part 3 then returns this content address CA to a file system in the storage system 1 (an arrow Y7 in FIG. 3). The storage system 1 manages identification information such as a file name of a file and the content address CA in association with each other in the file system.

Further, the data storage processing part 3 manages a content address CA of block data D and a hash value H of the block data D in association with each other in the MFI file. Thus, the content address CA is stored in association with information specifying a file, the hash value H, and so on in the storage device.

Further, the storage system 1 has a function to retrieving a file stored as described above. For example, when the storage system 1 accepts a retrieval request with a specific file designated, the storage system 1 firstly designates a content address CA composed of a short hash that is part of a hash value corresponding to the file requested to be retrieved and logical position information, based on the file system. Then, the storage system 1 checks whether the content address CA is registered in the MFI file. When not registered, the requested data is not stored, so that the storage system 1 returns error.

On the other hand, when the content address CA relating to the retrieval request is registered, the storage system 1 specifies a storage position designated by the content address CA, and retrieves each fragment data stored in this specified storage position, as data requested to be retrieved. At this moment, in a case that data storage files storing the respective fragments and the storage position of the fragment data of one of the data storage files are known, it is possible to specify the storage position of other fragment data based on the same storage position.

Then, the storage system 1 restores block data D from the respective fragment data retrieved in response to the retrieval request. Moreover, the storage system 1 connects a plurality of restored block data D, restores into a group of data like a file A, and returns it.

Further, when a data write request is made by any of the client devices 21 to 24, the data characteristics measuring part 4 (a data characteristics measuring means) measures preliminarily set characteristics of the data transmitted by the above client device, for example, preliminarily set characteristics of write data to be written actually. In this exemplary embodiment, the data characteristics measuring part 4 measures the reception amount, duplication rate and compression rate of write data to be written that is requested to be written within a predetermined period by any of the client devices 21 to 24. The data characteristics measuring part 4 then stores the measured reception amount, duplication rate and compression rate into the client management table 5 (a client device table) in association with the IP address of the above client device having transmitted this write data.

In FIG. 4, one example of the client management table 5 is shown. As shown in this figure, in the client management table 5, the IP addresses of the respective client devices 21 to 24, the external network ports 11 to 14 connected so as to correspond to the respective client devices 21 to 24, and the abovementioned reception amounts, duplication rates and compression rates of write data transmitted by the respective client devices 21 to 24 are stored in association with each other.

To be specific, upon reception of write data from any of the client devices 21 to 24, the data characteristics measuring part 4 measures the reception amount of the write data. Then, the data characteristics measuring part 4 updates a reception amount corresponding to the client device having transmitted the write data, which is stored in the client management table 5, by adding the measured reception amount thereto.

Further, for each of the client devices 21 to 24, the data characteristics measuring part 4 measures a duplication rate representing a ratio of judgment that write data transmitted from the above client device has already been stored by the duplication determination function of the abovementioned data storage processing part 3. For example, the data characteristics measuring part 4 measures, as the duplication rate, a ratio of the number of duplicate blocks to the number of blocks of writing data having been received heretofore within a predetermined period. Then, the data characteristics measuring part 4 updates a duplication rate corresponding to the client device having transmitted the write data, which is stored in the client management table 5, to the measured duplication rate.

Further, for each of the client devices 21 to 24, the data characteristics measuring part 4 measures the compression rate of write data transmitted from the above client device when the data is compressed and stored by the data compression function of the data storage processing part 3. For example, the data characteristics measuring part 4 measures, as a compression rate, an average value of compression rates of the respective blocks configuring write data having been received heretofore within a predetermined period. Then, the data characteristics measuring part 4 updates a compression rate corresponding to the client device having transmitted the write data, which is stored in the client management table 5, to the measured compression rate.

Further, the connection managing part 2 (a connection managing means) manages connection statuses between the client devices 21 to 24 connected with the storage system 1 via the network N and the external network ports 11 to 14. Specifically, the connection managing part 2 in this exemplary embodiment periodically operates to change allocation of the external network ports 11 to 14 to the client devices 21 to 24 based on the information recorded in the client management table 5 described above.

For example, in a case that it is preliminarily set to allocate the external network ports 11 to 14 based on the duplication rates, the connection managing part 2 sorts the client devices, namely, the IP addresses in the client management table 5 in the descending order of the duplication rates. In a case that it is preliminarily set to allocate the external network ports 11 to 14 based on the compression rates, the connection managing part 2 sorts the IP addresses in the client management table 5 in the descending order of the compression rates. In a case that it is preliminarily set to allocate the external network ports 11 to 14 based on the reception amounts, the connection managing part 2 sorts the IP addresses in the client management table 5 in the descending order of the reception amounts.

Then, the connection managing part 2 allocates the external network ports 11 to 14 in a previously set order to the IP addresses sorted as described above in order, and rewrites in association with the IP addresses in the client management table 5. For example, the connection managing part 2 associates the external network ports 11 to 14 in the descending order of bands thereof with the sorted IP addresses and rewrites the client management table 5.

Furthermore, the connection managing part 2 changes connections between the client devices 21 to 24 and the external network ports 11 to 14 so as to agree with an association relation between the IP addresses and the external network ports 11 to 14 stored in the client management table 5 rewritten as described above.

To be specific, the connection managing part 2 has a GARP (Gratuitous Address Resolution Protocol) transmission function and, in response to an ARP request transmitted by any of the client devices 21 to 24 for the purpose of knowing the MAC address of the storage system 1, confirms whether the IP address of the above client device and any of the external network ports 11 to 14 are recorded in the client management table 5. When recorded, the connection managing part 2 returns an ARP with the MAC address of the above external network port included. On the other hand, when not recorded, the connection managing part 2 selects one of the external network addresses 11 to 14 in accordance with a round robin rule. Then, the connection managing part 2 records the client IP address and the external network port allocated thereto into the client management table 5, and also returns an ARP with the

MAC address of the selected external network port included. Consequently, an ARP table of the above client device is updated, and a connection between the client device and the external network port is stored in the client management table 5.

[Operation]

Next, an operation of the storage system 1 described above will be explained with reference to flowcharts of FIGS. 5 to 7. At the beginning, with reference to FIG. 5, an operation when any of the client devices 21 to 24 and the storage system 1 are connected via any of the external network ports 11 to 14 will be explained.

Firstly, any of the client devices 21 to 24 sends an ARP request to the storage system 1 connected therewith in order to know the MAC address of the storage system 1 (step S1). Next, the storage system 1 having received the ARP request confirms whether the IP address of the above client device and any of the external network ports 11 to 14 are recorded in association with each other in the client management table 5 (step S2). When recorded (step S2: Yes), the storage system 1 returns an ARP with the MAC address of the external network port included to the client device (step S3).

On the other hand, when it is judged that the IP address of the above client device and any of the external network ports 11 to 14 are not recorded in association with each other at step S2 (step S2: No), the storage system 1 selects one of the external network ports 11 to 14 in accordance with the round robin rule (step S4). Then, the storage system 1 records the selected external network port into the client management table 5 in association with the IP address of the client device (step S5). After that, the storage system 1 returns an ARP with the MAC address of the selected external network port included to the client device (step S3).

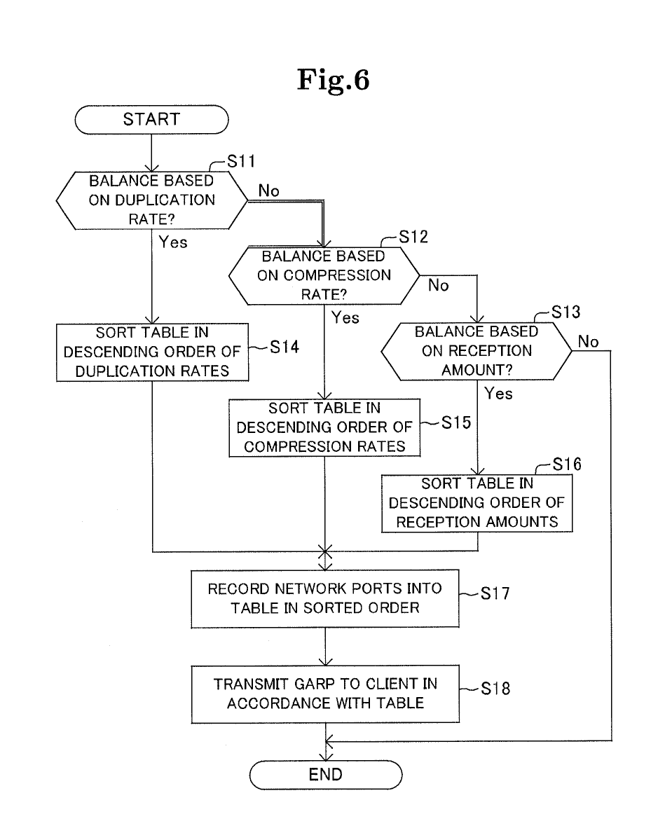

Subsequently, with reference to FIG. 6, an operation when an external network port used for being connected with a client device is changed will be described. At first, the connection managing part 2 is periodically invoked by a timer to operate. The connection managing part 2 then executes allocation of an external network port based on the information recorded in the client management table 5. At this moment, the connection managing part 2 firstly confirm a criterion which the connection managing part 2 executes allocation of an external network port based on (steps S11, S12 and S13).

For example, in a case that it is preliminarily set to execute the allocation based on “duplication rates” (step S11: Yes), the connection managing part 2 sorts the client management table 5 in order of client devices having IP addresses associated with data of high “duplication rates” (step S14). In a case that it is preliminarily set to execute the allocation based on “compression rates” (step S12: Yes), the connection managing part 2 sorts the client management table 5 in order of client devices having IP addresses associated with data of high “compression rates” (step S15). In a case that it is preliminarily set to execute the allocation based on “reception amounts” (step S13: Yes), the connection managing part 2 sorts the client management table 5 in order of client devices having IP addresses associated with data of high “reception amounts” (step S16).

Subsequently, the connection managing part 2 allocates the entries of the external network ports in the client management table 5 in a preliminarily set order of the external network ports to the client devices sorted as described above in order, and rewrites the client management table 5 (step S17). After that, in accordance with the rewritten client management table 5, the connection managing part 2 transmits a GARP to each of the client devices 21 to 24 by the GARP transmission function thereof (step S18). Consequently, the ARP table of each of the client devices 21 to 24 is updated, and a connection between the client device and the external network port is changed.

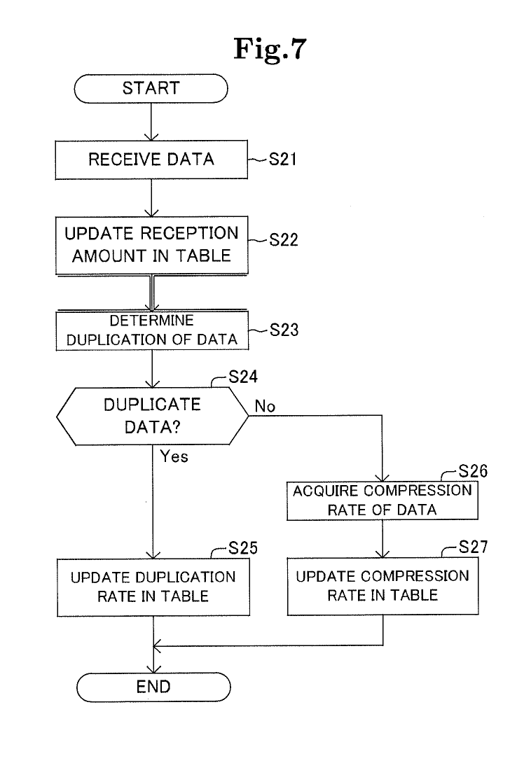

Next, with reference to FIG. 7, an operation when the duplication rates, compression rates and reception amounts in the client management table 5 are updated in the storage system 1 will be described.

At first, the storage system 1 receives write data to be written from any of the client devices 21 to 24 (step S21). Then, the storage system 1 measures the reception amount of the write data, and updates a reception amount of the client device having transmitted the write data, which is stored in the client management table 5, by adding the reception amount of the write data thereto (step S22).

Subsequently, the storage system 1 executes a process to store the write data into the data storing part 6. At this moment, the storage system 1 checks by the duplication determination function whether the write data has already been stored (step S23). In a case that the write data is duplicate data having already been stored in the data storing part 6 (step S23: Yes), the storage system 1 calculates the duplication rate of the write data transmitted from the client device having transmitted this write data. Then, the storage system 1 updates a duplication rate of the client device having transmitted the write data, which is stored in the client management table 5 (step S25).

On the other hand, in a case that the write data has not been stored in the data storing part 6 yet (step S24: No), as described before, the storage system 1 divides the write data into blocks and stores these blocks in the compression state. The storage system 1 calculates a compression rate of the blocks at this moment for each of the client devices 21 to 24, and updates a compression rate of the client device having transmitted write data, which is stored in the client management table 5 (step S29).

After that, the client management table 5 having been thus updated is sorted based on the respective values (the duplication rates, compression rates and reception amounts) as shown by the flowchart of FIG. 6, and allocation of external network ports to the client devices 21 to 24 is executed.

The process of the flowchart shown in FIG. 6 may be executed at a time that the client management table 5 is updated, for example. That is to say, at a time that the client management table 5 is updated, allocation of the external network ports 11 to 14 is changed depending on a situation at the time, and a GARP as information representing the allocation of the external network ports is transmitted to the client devices 21 to 24. Consequently, the ARP tables of the client devices 21 to 24 are updated, and connections between the client devices 21 to 24 and the external network ports 11 to 14 are changed.

Thus, the storage system 1 of this exemplary embodiment can allocate an external network port depending on characteristics (a duplication rate, a compression rate, a reception amount, and the like) of write data transmitted from any of the client devices 21 to 24, and can realize efficient data writing. For example, it is possible to realize allocation of the external network ports 11 to 14 connected to the client devices 21 to 24 so that throughput and load balancing efficiency of the storage system 1 with respect to the client devices 21 to 24 become the highest.

Although a configuration of comparing characteristics of write data requested to be written by the client devices 21 to 24 in the client management table 5 among the client devices 21 to 24 and allocating the external network ports 11 to 14 depending on the result of the comparison has been described above, the allocation method is not limited to the abovementioned method. For example, depending on the values of the characteristics of the write data described above, any of the external network ports 11 to 14 may be allocated based on a preset criterion.

### Second Exemplary Embodiment

Next, a second exemplary embodiment of the present invention will be described. A storage system of this exemplary embodiment has almost the same configuration as that of the first exemplary embodiment described above, but is different from that of the abovementioned exemplary embodiment in determination criterion for allocating the external network ports 11 to 14. That is to say, allocation of the external network ports 11 to 14 is executed depending on the characteristics of write data requested to be written transmitted from the client devices 21 to 24 in the storage system 1 of the first exemplary embodiment, but the allocation is executed based on other data transmitted from the client devices 21 to 24 when a write request is made in this exemplary embodiment.

To be specific, the data characteristics measuring part 4 of the storage system 1 in this exemplary embodiment checks a path name as a write destination, data size and file format of write data to be written. Moreover, the data characteristics measuring part 4 checks information representing a method of accessing the data storing part 6 when write data to be written is written, the priority of a write process, and so on. Then, the connection managing part 2 of the storage system 1 in this exemplary embodiment allocates any of the external network ports 11 to 14 to the client device making a write request, based on the checked information.

For example, when allocating an external network port based on a file path name that is a write destination of write data, the connection managing part 2 determines an external network port to be allocated by considering the performance characteristics of each storage: for example, allocates a high-speed storage to one path and vice versa.

Further, when allocating an external network port based on the size of write data, the connection managing part 2 determines a network port to be allocated by tracking write offset of a file that is write data and analogizing the size of the file and the way of I/O (sequential access or random access). For example, when intending to sequentially write data with certain offset or more, the connection managing part 2 judges that high throughput is obtained and allocates a broadband external network. On the contrary, when judging that a large number of small files are being written or random I/O is performed, the connection managing part 2 allocates narrowband network ports so as to gather such connections thereto. This is because it is impossible to expect high throughput from one connection.

Further, when allocating an external network port based on the priority of a write process, the connection managing part 2 writes information on the priority of a write process informed by a client device at the time of establishment of a connection into the client management table 5, and allocates an external network port in accordance with the content of the priority instruction.

Furthermore, the client management table 5 is recorded for a long time period, for example, by hours and days. Then, in accordance with a write status of each client device for a long time period, it is possible to determine allocation of external network ports. For example, in accordance with the duplication rate, reception amount, and the like of write data of each client device every day of the week, allocation of external network ports is determined.

### Third Exemplary Embodiment

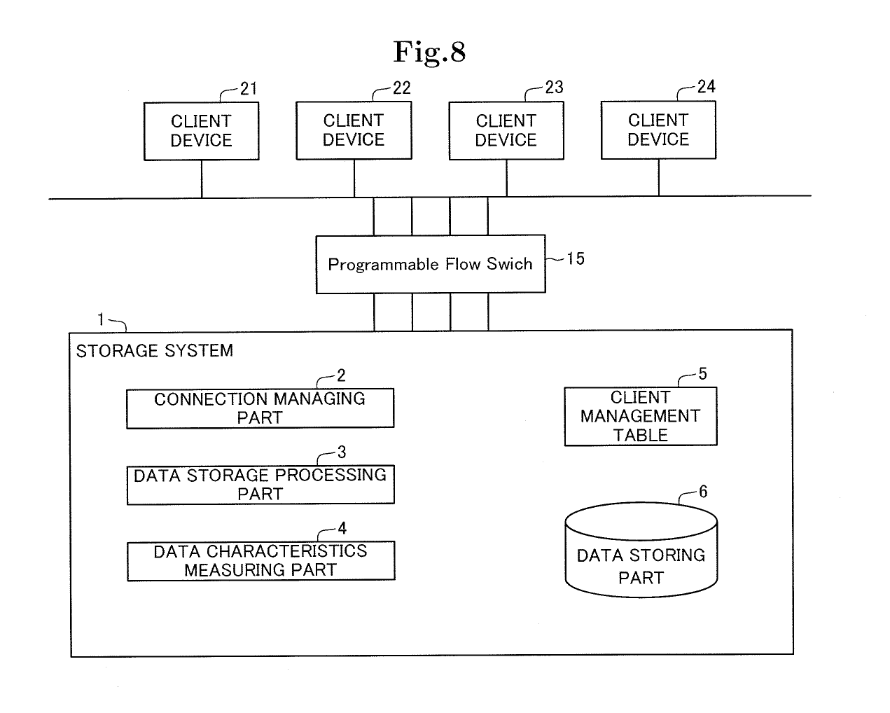

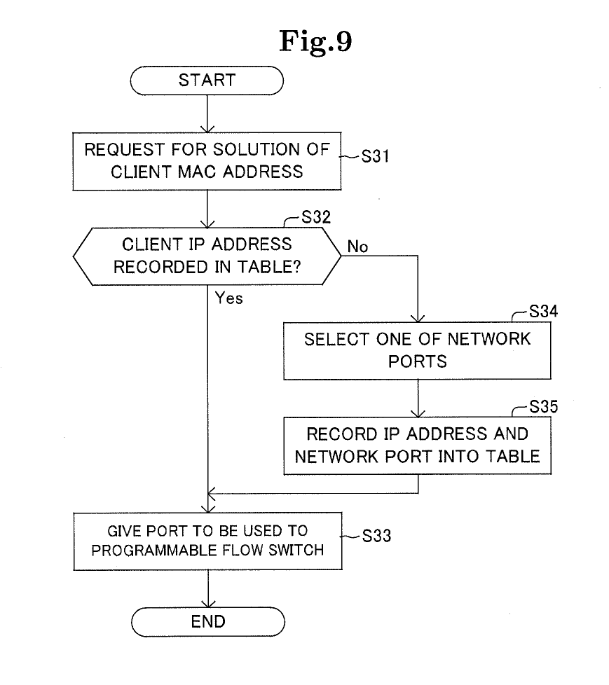

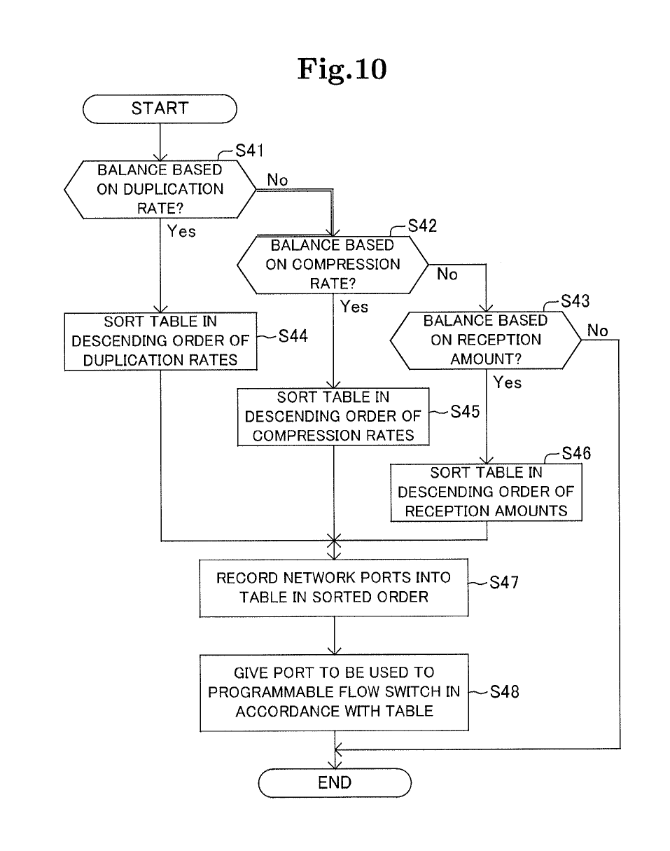

A third exemplary embodiment of the present invention will be described with reference to FIGS. 8 to 10. FIG. 8 is a block diagram showing a configuration of the storage system 1 in this exemplary embodiment, and FIGS. 9 and 10 are flowcharts showing an operation of the storage system 1.

The storage system 1 in this exemplary embodiment does not use an ARP when allocating external network ports connected to the client devices 21 to 24, and uses a Programmable Flow Switch (a switch device) instead. Therefore, as shown in FIG. 8, between the client devices 21 to 24 and the storage system 1, a Programmable Flow Switch 15 having a plurality of external network ports is connected. When the connection managing part 2 of the storage system 1 gives a control instruction to the Programmable Flow Switch 15, it is possible to execute control of connections between the client devices 21 to 24 and the external network ports.

Below, an operation of the storage system 1 in this exemplary embodiment will be described, but is basically the same as the operations in the first and second exemplary embodiments.

At the beginning, with reference to FIG. 9, an operation when any of the client devices 21 to 24 is connected with the storage system 1 via any of the external network ports 11 to 14 will be described. Firstly, to the storage system 1 to be connected, the above client device sends a request for knowing the MAC address of the storage system 1 (step S31). Next, the storage system 1 confirms whether the IP addresses of the client device and the above external network port are recorded in association with each other in the client management table 5 (step S32). When recorded (step S32: Yes), the storage system 1 gives a port to be used to the Programmable Flow Switch 15 so as to connect the external network port and the client device (step S33). When not recorded (step S32: No), the storage system 1 selects one of the external network ports 11 to 14 in accordance with the round robin rule (step S34). Then, the IP address of the client device and the selected external network port are recorded in the client management table 5 (step S35). After that, the storage system 1 instructs the Programmable Flow Switch 15 to use the selected external network port (step S33).

Subsequently, with reference to FIG. 10, an operation when an external network port connected to a client device is changed. Firstly, the connection managing part 2 is periodically invoked by a timer to operate. Then, the connection managing part 2 executes allocation of external network ports based on information recorded in the client management table 5. The connection managing part 2 first confirms a criterion which the connection managing part 2 allocates external network ports based on (steps S41, S42 and S43).

For example, in a case that it is preliminarily set to perform the allocation based on “duplication rates” (step S41: Yes), the connection managing part 2 sorts the client management table 5 in the order of client devices having IP addresses associated with data of high “duplication rates” (step S44). In a case that it is preliminarily set to perform the allocation based on “compression rates” (step S42: Yes), the connection managing part 2 sorts the client management table 5 in the order of client devices having IP addresses associated with data of high “compression rates” (step S45). In a case that it is preliminarily set to perform the allocation based on “reception amounts” (step S43: Yes), the connection managing part 2 sorts the client management table 5 in the order of client devices having IP addresses associated with data of high “reception amounts” (step S46).

Subsequently, the connection managing part 2 allocates the entries of the external network ports in the client management table 5 in a preliminarily set order of external network ports to the client devices sorted as described above in order, and rewrites the client management table 5 (step S47). After that, in accordance with the rewritten client management table 5, the connection managing part 2 gives an external network port to be used to the Programmable Flow Switch 15 so that the port is connected with the client device (step S48).

Because the duplication rates, compression rates and reception amounts in the client management table 5 are updated in the same as in the first exemplary embodiment described above, a detailed explanation thereof will be omitted. Moreover, as described in the second exemplary embodiment, in accordance with information transmitted when any of the client devices 21 to 24 makes a write request, such as a path name as a destination to write data, a data size, a file format, an access method for writing data and the priority of a write process, the storage system 1 may allocate an external network port to the above client device and give a port to be used to the programmable Flow Switch 15.

Thus, by using the Programmable Flow Switch 15, it is possible to realize allocation of external network ports without a status control of an ARP table on a client side.

In the respective exemplary embodiments, a description has been made assuming the storage system 1 is a content-addressable storage system. The storage system 1 of the present invention can also be applied to any storage system connected with an IP (Internet Protocol) network like a virtualized storage such as a NAS (Network-Attached Storage) and a NAS switch.

<Supplementary Notes>

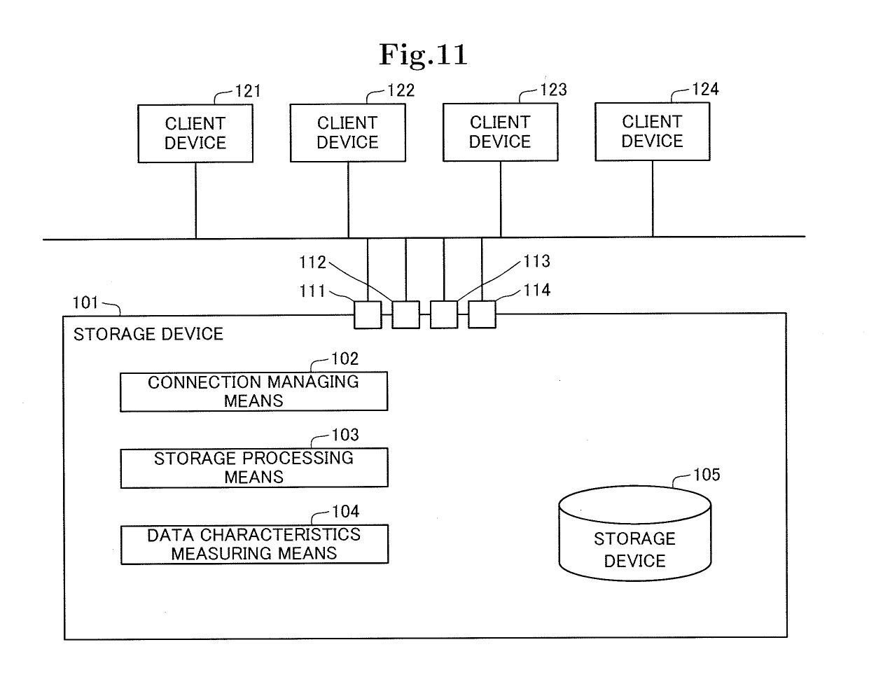

The whole or part of the exemplary embodiments disclosed above can be described as the following supplementary notes. Below, the outline of a configuration of a storage device 101 according to the present invention will be described with reference to FIG. 11. Moreover, configurations of a storage system, a program and a data processing method will be described. However, the present invention is not limited to the following configurations.

(Supplementary Note 1)

A storage device 101, comprising:

a connection managing means 102 for managing a status of a connection between network ports 111 to 114 and client devices 121 to 124 connected via the network ports;

a storage processing means 103 for receiving write target data transmitted from the client devices 121 to 124 and storing the data into a predetermined storage device 105; and

a data characteristics measuring means 104 for executing measurement of a predetermined characteristic of predetermined data received when a write request is made by the client devices 121 to 124,

wherein the connection managing means 102 is configured to change the network ports 111 to 114 connected with the client devices 121 to 124 in accordance with a result of the measurement by the data characteristics measuring means 104.

(Supplementary Note 2)

The storage device according to Supplementary Note 1, wherein the data characteristics measuring means is configured to execute measurement of a predetermined characteristic of the write target data received from the client devices.

(Supplementary Note 3)

The storage device according to Supplementary Note 2, wherein:

the data characteristics measuring means is configured to store a result of the measurement of the predetermined characteristic of the write target data received from the client devices and client information specifying the client devices having transmitted the write target data, into a client information table in association with each other; and

the connection managing means is configured to change the network ports connected with the client devices depending on a content stored in the client information table.

(Supplementary Note 4)

The storage device according to Supplementary Note 3, wherein the data characteristics measuring means is configured to store a result of a measurement of the predetermined characteristic of the write target data received from the client devices within a predetermined period and client information specifying the client devices having transmitted the write target data, into the client information table in association with each other.

(Supplementary Note 5)

The storage device according to Supplementary Note 4, wherein the data characteristics measuring means is configured to measure, for each of the client devices, a reception amount of the write target data received from the client device, as the predetermined characteristic.

(Supplementary Note 6)

The storage device according to Supplementary Note 4 or 5, wherein:

the storage processing means is configured to check whether the new write target data received from the client devices is a duplicate of data already stored in the storage device and, when the new write target data is the duplicate of the already stored data, set to refer to a storage position of the data already stored in the storage device as a storage position of the new write target data, without storing the new write target data into the storage device; and

the data characteristics measuring means is configured to measure, for each of the client devices, a duplication rate representing a degree of duplication of the write target data received from the client device with the data already stored in the storage device, as the predetermined characteristic.

(Supplementary Note 7)

The storage device according to any of Supplementary Notes 4 to 6, wherein:

the storage processing means is configured to check whether the new write target data received from the client devices is a duplicate of data already stored in the storage device and, when the new write target data is not the duplicate of the already stored data, compress the new write target data and store the data into the storage device; and

the data characteristics measuring means is configured to measure, for each of the client devices, a compression rate of the write target data received from the client device, as the predetermined characteristic.

(Supplementary Note 8)

The storage device according to any of Supplementary Notes 1 to 7, wherein the data characteristics measuring means is configured to measure, as the predetermined characteristic, information representing a path name as a write destination of the write target data, the information being received from the client devices when a write request is made.

(Supplementary Note 9)

The storage device according to any of Supplementary Notes 1 to 8, wherein the data characteristics measuring means is configured to measure, as the predetermined characteristic, information representing a data size of the write target data, the information being received from the client devices when a write request is made.

(Supplementary Note 10)

The storage device according to any of Supplementary Notes 1 to 9, wherein the data characteristics measuring means is configured to measure, as the predetermined characteristic, information representing a file format of the write target data, the information being received from the client devices when a write request is made.

(Supplementary Note 11)

The storage device according to any of Supplementary Notes 1 to 10, wherein the data characteristics measuring means is configured to measure, as the predetermined characteristic, information representing a method for accessing the storage device of the write target data, the information being received from the client devices when a write request is made.

(Supplementary Note 12)

The storage device according to any of Supplementary Notes 1 to 11, wherein the data characteristics measuring means is configured to measure, as the predetermined characteristic, information representing a priority of a writing process, the information being received from the client devices when a write request is made.

(Supplementary Note 13)

A storage system, comprising a storage device and a switch device having a plurality of network ports relaying a connection between the storage device and client devices via a network,

wherein the storage device comprises:
a connection managing means for controlling an operation of the switch device and managing a status of a connection between the client devices and the connected network ports;
a storage processing means for receiving write target data transmitted from the client devices and storing the data into a predetermined storage device; and
a data characteristics measuring means for executing measurement of a predetermined characteristic of predetermined data received when a write request is made by the client devices; and

wherein the connection managing means is configured to change the network ports connected with the client devices in accordance with a result of the measurement by the data characteristics measuring means.

(Supplementary Note 14)

The storage system according to Supplementary Note 13, wherein the data characteristics measuring means is configured to measure a predetermined characteristic of the write target data received from the client devices.

(Supplementary Note 15)

A computer program comprising instructions for causing an information processing device to realize:

a connection managing means for managing a status of a connection between network ports and client devices connected via the network ports;

a storage processing means for receiving write target data transmitted from the client devices and storing the data into a predetermined storage device; and

a data characteristics measuring means for executing measurement of a predetermined characteristic of predetermined data received when a write request is made by the client devices,

wherein the connection managing means is configured to change the network ports connected with the client device in accordance with a result of the measurement by the data characteristics measuring means.

(Supplementary Note 16)

The computer program according to Supplementary Note 15, wherein the data characteristics measuring means is configured to measure a predetermined characteristic of the write target data received from the client devices.

(Supplementary Note 17)

A data processing method, comprising:

managing a status of a connection between network ports and client devices connected via the network ports;

receiving write target data transmitted from the client devices and storing the data into a predetermined storage device; and

executing measurement of a predetermined characteristic of predetermined data received when a write request is made by the client devices and, in accordance with a result of the measurement, changing the network ports connected with the client devices.

(Supplementary Note 18)

The data processing method according to Supplementary Note 17, comprising, when a write request is made by the client devices, executing measurement of a predetermined characteristic of the write target data received from the client devices and, in accordance with a result of the measurement, changing the network ports connected with the client devices.

Although the present invention has been described above with reference to the respective exemplary embodiments, the present invention is not limited to the exemplary embodiments described above. The configurations and details of the present invention can be altered in various manners that can be understood by those skilled in the art within the scope of the present invention.

The present invention is based upon and claims the benefit of priority from Japanese patent application No. 2010-27123, filed on Feb. 10, 2010, the disclosure of which is incorporated herein in its entirety by reference.

### DESCRIPTION OF REFERENCE NUMERALS

1 storage system
2 connection managing part
3 data storage processing part
4 data characteristics measuring part
5 client management table
6 data storing part
11 to 14 external network port
21 to 24 client device
101 storage device
102 connection managing means
103 storage processing means
104 data characteristics measuring means
105 storage device
111 to 114 network port
121 to 124 client device

1. A storage device, comprising:
a connection managing unit for managing a status of a connection between network ports and client devices connected via the network ports;
a storage processing unit for receiving write target data transmitted from the client devices and storing the data into a predetermined storage device; and
a data characteristics measuring unit for executing measurement of a predetermined characteristic of predetermined data received when a write request is made by the client devices,
wherein the connection managing unit is configured to change the network ports connected with the client devices in accordance with a result of the measurement by the data characteristics measuring unit.

2. The storage device according to claim 1, wherein the data characteristics measuring unit is configured to execute measurement of a predetermined characteristic of the write target data received from the client devices.

3. The storage device according to claim 2, wherein:
the data characteristics measuring unit is configured to store a result of the measurement of the predetermined characteristic of the write target data received from the client devices and client information specifying the client devices having transmitted the write target data, into a client information table in association with each other; and
the connection managing unit is configured to change the network ports connected with the client devices depending on a content stored in the client information table.

4. The storage device according to claim 3, wherein the data characteristics measuring unit is configured to store a result of a measurement of the predetermined characteristic of the write target data received from the client devices within a predetermined period and client information specifying the client devices having transmitted the write target data, into the client information table in association with each other.

5. The storage device according to claim 4, wherein the data characteristics measuring unit is configured to measure, for each of the client devices, a reception amount of the write target data received from the client device, as the predetermined characteristic.

6. The storage device according to claim 4, wherein:
the storage processing unit is configured to check whether the new write target data received from the client devices is a duplicate of data already stored in the storage device and, when the new write target data is the duplicate of the already stored data, set to refer to a storage position of the data already stored in the storage device as a storage position of the new write target data, without storing the new write target data into the storage device; and
the data characteristics measuring unit is configured to measure, for each of the client devices, a duplication rate representing a degree of duplication of the write target data received from the client device with the data already stored in the storage device, as the predetermined characteristic.

7. The storage device according to claim 4, wherein:
the storage processing unit is configured to check whether the new write target data received from the client devices is a duplicate of data already stored in the storage device and, when the new write target data is not the duplicate of the already stored data, compress the new write target data and store the data into the storage device; and
the data characteristics measuring unit is configured to measure, for each of the client devices, a compression rate of the write target data received from the client device, as the predetermined characteristic.

8. (canceled)

9. A computer-readable medium storing a program comprising instructions for causing an information processing device to realize:
a connection managing unit for managing a status of a connection between network ports and client devices connected via the network ports;
a storage processing unit for receiving write target data transmitted from the client devices and storing the data into a predetermined storage device; and
a data characteristics measuring unit for executing measurement of a predetermined characteristic of predetermined data received when a write request is made by the client devices,
wherein the connection managing unit is configured to change the network ports connected with the client device in accordance with a result of the measurement by the data characteristics measuring unit.

10. A data processing method, comprising:
managing a status of a connection between network ports and client devices connected via the network ports;
receiving write target data transmitted from the client devices and storing the data into a predetermined storage device; and
executing measurement of a predetermined characteristic of predetermined data received when a write request is made by the client devices and, in accordance with a result of the measurement, changing the network ports connected with the client devices.

11. The storage device according to claim 1, wherein the data characteristics measuring means is configured to measure, as the predetermined characteristic, information representing a path name as a write destination of the write target data, the information being received from the client devices when a write request is made.

12. The storage device according to claim 1, wherein the data characteristics measuring means is configured to measure, as the predetermined characteristic, information representing a data size of the write target data, the information being received from the client devices when a write request is made.

13. The storage device according to claim 1, wherein the data characteristics measuring means is configured to measure, as the predetermined characteristic, information representing a file format of the write target data, the information being received from the client devices when a write request is made.

14. The storage device according to claim 1, wherein the data characteristics measuring means is configured to measure, as the predetermined characteristic, information representing a method for accessing the storage device of the write target data, the information being received from the client devices when a write request is made.

15. The storage device according to claim 1, wherein the data characteristics measuring means is configured to measure, as the predetermined characteristic, information representing a priority of a writing process, the information being received from the client devices when a write request is made.
